(19) United States
(12) Patent Application Publication
(10) Pub. No.: US 2026/0099934 A1
(43) Pub. Date: Apr. 9, 2026

(54) METHODS AND SYSTEMS FOR ESTIMATING DEPTH OF IMAGE FRAMES FOR USE IN HEAD-MOUNTED DEVICE

(71) Applicant: Samsung Electronics Co., Ltd., Suwon-si (KR)

(72) Inventors: Siddharth ARAVINDAN, Bangalore (IN); Ankit DHIMAN, Bangalore (IN); Basavaraja Shanthappa VANDROTTI, Bangalore (IN); Pushkar Raj SINGH, Bangalore (IN); Lokesh Rayasandra BOREGOWDA, Bangalore (IN); Jooyoung KIM, Suwon-si (KR); Kihwan KIM, Suwon-si (KR)

(21) Appl. No.: 19/345,269

(22) Filed: Sep. 30, 2025

Related U.S. Application Data
(63) Continuation of application No. PCT/KR2025/015478, filed on Sep. 30, 2025.

(30) Foreign Application Priority Data
Oct. 4, 2024 (IN) 202441075109

(51) Int. Cl. G06T 7/55; G06T 7/521

(52) U.S. Cl. CPC G06T 7/55; G06T 7/521; G06T 2207/10028

(57) ABSTRACT

Methods and systems for estimating a depth of one or more image frames for use in a head-mounted device (HMD) are provided. The method includes capturing, by the HMD, the one or more image frames, extracting, by the HMD, one or more features from each of the one or more image frames, predicting, by the HMD, a minimum number of depth sampling points for estimating the depth of each of the one or more image frames using the one or more extracted features, and estimating, by the HMD, the depth of each of the one or more image frames using the corresponding minimum number of depth sampling points.

### CROSS-REFERENCE TO RELATED APPLICATION(S)

This application is a continuation application, claiming priority under 35 U.S.C. § 365(c), of an International application No. PCT/KR2025/015478, filed on Sep. 30, 2025, which is based on and claims the benefit of an Indian patent application number 202441075109, filed on Oct. 4, 2024, in the Indian Patent Office, the disclosure of which is incorporated by reference herein in its entirety.

### FIELD OF THE INVENTION

The disclosure relates to the field of virtual environment. More particularly, the disclosure relates to methods and systems for estimating a depth of one or more image frames for use in a head-mounted device (HMD).

### BACKGROUND

Extended reality (XR) technologies can be used to present virtual content to users, and/or can combine real environments from the physical world and virtual environments to provide users with extended reality experiences. The term extended reality can encompass virtual reality, augmented reality, mixed reality, and the like.

Extended reality systems allow users to experience extended reality environments by overlaying virtual content onto images of a real-world environment, which can be viewed by a user through an extended reality device (e.g., a head-mounted display, extended reality glasses, or other devices). The real-world environment can include physical objects, people, or other real-world objects. XR technology is implemented in various applications and fields, including entertainment (e.g., gaming), teleconferencing, and education, among other applications and fields. Currently, the XR systems are being developed to provide users with the ability to capture photographs or videos.

Therefore, high-quality depth image information plays a vital role in the XR technology based on depth information. Further, accurate depth estimation of points in a real-world scene is important for a wide range of XR use cases including three-dimensional (3D) scene reconstruction and passthrough.

However, current consumer-level depth cameras have the problems of poor image quality, sparse depth images, or missing depth values, such as holes. More preferably, currently, XR devices, such as a video see-through (VST) device, are used to measure the depth of a scene, specifically, in the real-world scene that is being viewed by a user.

The VST device uses sensors, specifically direct time of flight (D-ToF) sensors for retrieving spot depth samples of the real-world scene. Thereafter, the spot depth samples are used by a depth completion model to predict a depth map of the real-world scene. However, gathering depth input of all image pixels is infeasible using accurate D-ToF sensors due to high power consumption.

The above information is presented as background information only to assist with an understanding of the disclosure. No determination has been made, and no assertion is made, as to whether any of the above might be applicable as prior art with regard to the disclosure.

### SUMMARY

However, these spot depth samples have a uniformly distributed grid of points, due to which sample points may miss regions with densely varying depths. Further, most of the sample points fall on featureless regions, which results in a fixed number of sample points. Therefore, high-quality visualisation of real-world scenes cannot be obtained as the images require varying number of sample points.

Other techniques of the related art, such as indirect time-of-flight (I-ToF), provide dense depth maps but are highly inaccurate. Moreover, using these techniques for downstream tasks can further degrade the user experience.

Further, there are depth completion methods that predict a full depth map based on the depth values of a subset of image pixels (i.e., a sparse depth map). Common, but less effective, techniques for selecting this subset include uniformly sampling image pixels, as shown in FIG. 1.

FIG. 1 illustrates a pictorial representation of uniform sampling of a real world image according to the related art.

Referring to FIG. 1, a real world image 101 of a road is sampled using uniform samples 103 throughout the frame. However, these methods are suboptimal because these techniques do not consider the structure of an image of the real-world scene or the effectiveness of a depth completion approach on such images in the real-world scene.

Therefore, techniques of the related art lead to a poor user experience due to poor depth map prediction. In addition, there is a frequent battery drain in a battery of the XR devices and excessive heating due to high power consumption by the XR devices. This results in the device needing to augment an external battery pack.

Therefore, in view of the problems mentioned above, there is a need to provide techniques for adaptive depth sampling.

Aspects of concepts, in are to address at least the above-mentioned problems and/or disadvantages and to provide at least the advantages described below. Accordingly, an aspect of the disclosure is to provide methods and systems for estimating a depth of one or more image frames for use in a head-mounted device (HMD).

Additional aspects will be set forth in part in the description which follows and, in part, will be apparent from the description, or may be learned by practice of the presented embodiments.

In accordance with an aspect of the disclosure, a method for estimating a depth of one or more image frames for use in a head-mounted device (HMD) is provided. The method includes capturing (e.g., obtaining), by the HMD, the one or more image frames, extracting (e.g., identifying), by the HMD, one or more features from each of the one or more image frames, predicting (e.g., determining), by the HMD, a minimum number of depth sampling points for estimating the depth of each of the one or more image frames using the one or more extracted features, and estimating, by the HMD, the depth of each of the one or more image frames using the corresponding minimum number of depth sampling points.

In accordance with another aspect of the disclosure, a system for estimating a depth of one or more image frames for use in a head-mounted device (HMD) is provided. The system includes an image capturing device for capturing the one or more image frames, memory storing one or more computer programs, and a processor communicatively coupled to the image capturing device and the memory, wherein the one or more computer programs include computer-executable instructions that, when executed by the processor, cause the electronic device to extract one or more features from each of the one or more image frames, predict a minimum number of depth sampling points for estimating the depth of each of the one or more image frames using the one or more extracted features, and estimate the depth of each of the one or more image frames using the corresponding minimum number of depth sampling points.

In accordance with another aspect of the disclosure, one or more non-transitory computer-readable storage media storing one or more computer programs including computer-executable instructions that, when executed by one or more processors of an electronic device individually or collectively, cause the electronic device to perform operations of estimating a depth of one or more image frames for use in a head-mounted device (HMD) are provided. The operations include capturing, by the HMD, the one or more image frames, extracting, by the HMD, one or more features from each of the one or more image frames, predicting, by the HMD, a minimum number of depth sampling points for estimating the depth of each of the one or more image frames using the one or more extracted features, and estimating, by the HMD, the depth of each of the one or more image frames using the corresponding minimum number of depth sampling points.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a pictorial representation of uniform sampling of a real world image according to the related art;

FIG. 2A illustrates a virtual reality (VR) environment according to an embodiment of the disclosure;

FIG. 2B illustrates a block diagram of a system for estimating a depth of one or more image frames for use in a head-mounted device (HMD) according to an embodiment of the disclosure;

FIG. 3 illustrates an overall flow for estimating a depth of one or more image frames for use in an HMD according to an embodiment of the disclosure;

FIG. 4 illustrates a flow diagram depicting a method for estimating a depth of one or more image frames for use in an HMD according to an embodiment of the disclosure;

FIG. 5 illustrates a workflow diagram for predicting a minimum number of depth sampling points according to an embodiment of the disclosure;

FIG. 6 illustrates a workflow diagram for predicting a minimum number of depth sampling points according to an embodiment of the disclosure;

FIG. 7 illustrates a workflow diagram for predicting a minimum number of depth sampling points according to an embodiment of the disclosure;

FIG. 8 illustrates a comparison between depth sampling point required to estimate a depth of an image frame using an existing technique and a disclosed techniques according to an embodiment of the disclosure; and

FIG. 9 illustrates a use case scenario for estimating a depth of one or more image frames for use in the HMD according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface”includes reference to one or more of such surfaces.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises,” “comprising,” or any other variations thereof, are intended to cover a non-exclusive inclusion, such that a process or method that comprises a list of steps does not include only those steps but may include other steps not expressly listed or inherent to such process or method. Similarly, one or more systems or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

It should be noted that the terms stereo-camera setup and multi-camera setup have been used interchangeably throughout the specification and drawings.

The disclosure provides techniques for estimating a depth of one or more image frames for use in a head-mounted device (HMD). More particularly, the disclosure discloses techniques for predicting a subset of points that considers the structure of the image frames as well as tailors this subset to improve the estimation of the depth of the image frames. Accordingly, the disclosure provides an adaptive sampling approach that helps sample points in regions that are more helpful in predicting a good depth map.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

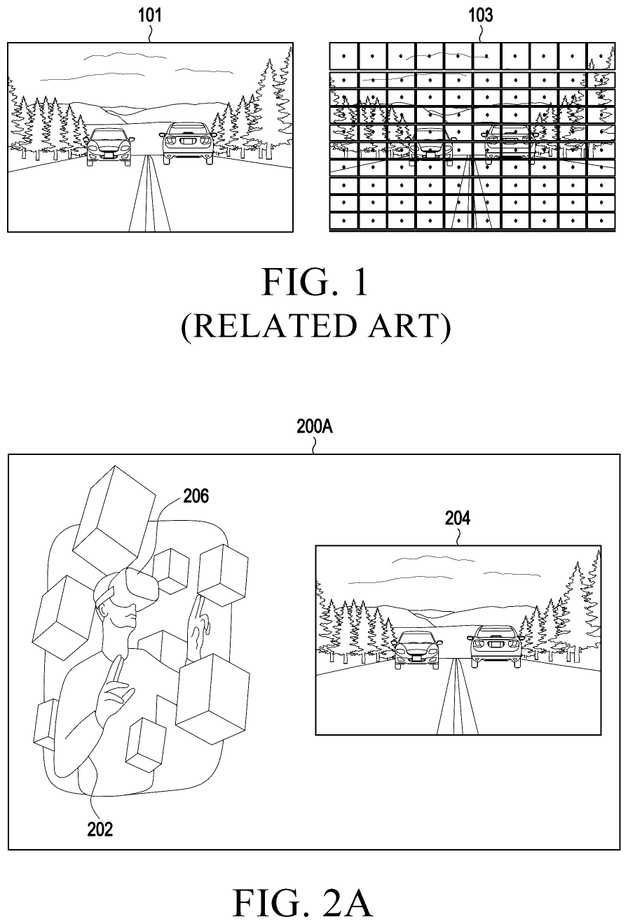

FIG. 1 illustrates a pictorial representation of uniform sampling of a real world image according to the related art.

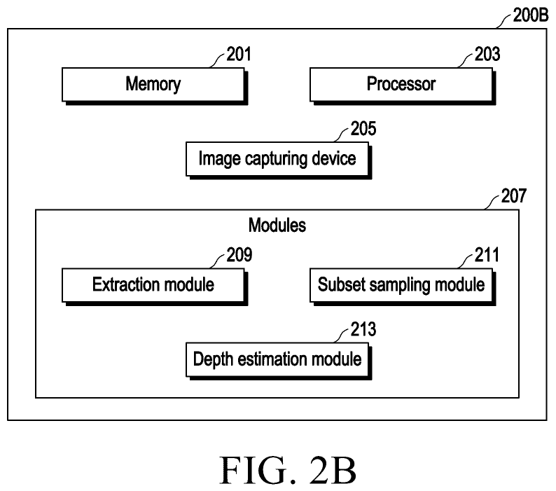

The disclosed techniques are further explained with respect to FIGS. 2A, 2B, and 3 to 9.

FIG. 2A illustrates an augmented reality (AR) environment according to an embodiment of the disclosure.

FIG. 2B illustrates a block diagram of a system for estimating a depth of one or more image frames for use in a head-mounted device (HMD) according to an embodiment of the disclosure. In an embodiment of the disclosure, a system 200B may be a part of the HMD 206 of FIG. 2A.

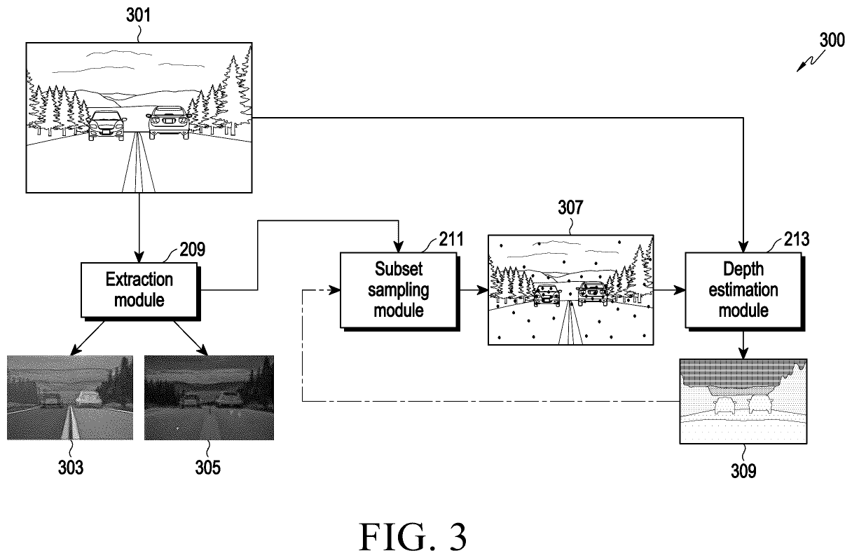

FIG. 3 illustrates an overall flow 300 for estimating a depth of one or more image frames for use in an HMD according to an embodiment of the disclosure.

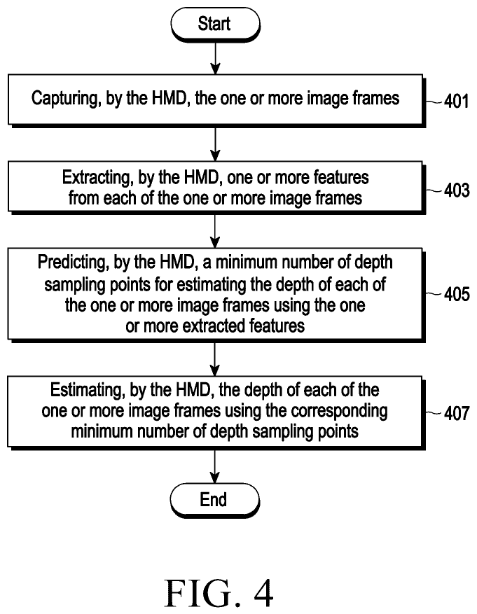

FIG. 4 illustrates a flow diagram depicting a method 400 for estimating a depth of one or more image frames for use in an HMD according to an embodiment of the disclosure. For the sake of brevity, the description of FIGS. 2A, 2B, 3, and 4 are explained in conjunction with each other.

Referring to FIG. 2A, an extended reality (XR) environment, such as augmented reality (AR) environment 200A is depicted where user 202 interacts with a real-world scene 204, such as real-world road like setting, which includes cars, trees, and mountains in the background. In an embodiment of the disclosure, the user 202 experiences the AR environment through a video-see-through (VST) device, such as a head-mounted display (HMD) 206. The HMD 206 is an electronic device worn around the user's head which is configured to provide XR content, such as AR content, mixed reality (MR) content, and virtual reality (VR) content. In an embodiment of the disclosure, an image-capturing device (not shown in FIG. 2A) may be connected to the HMD 206 via a network (not shown in FIG. 2A). In some embodiments of the disclosure, the image-capturing device may be attached to or integrated within the HMD 206. The image-capturing device may capture a plurality of real-world raw images of the real-world scene 204 and may transmit the plurality of real-world raw images to HMD 206. Accordingly, the image-capturing device may be facing the real-world scene 204 to capture the real-world raw images of the real-world scene 204. Further, in an embodiment of the disclosure, the network may be a public communications network (e.g., the Internet, cellular data network, dialup modems over a telephone network) or a private communications network (e.g., private local area network (LAN), leased lines). As shown, the user 202 may navigate the XR scene (i.e., the AR environment 200A) using his/her hands. Further, in an embodiment of the disclosure, the HMD 206 estimates the depth of one or more image frames of the real-world raw images using the techniques described in the following paragraphs. Accordingly, in an embodiment of the disclosure, the HMD 206 may be connected to the system 200B of FIG. 2B (explained below) to estimate the depth of one or more image frames of the real-world raw images using the techniques described herein.

Referring to FIG. 2B, the system 200B may include, but is not limited to, memory 201, a processor 203, an image capturing device 205, and modules 207. The memory 201, the image capturing device 205, and the modules 207 may be coupled to the processor 203.

The memory 201 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. Further, the memory 201 may include an operating system for performing one or more tasks of the system 200B, as performed by a generic operating system in the communications domain.

The processor 203 can be a single processing unit or several units, all of which could include multiple computing units. The processor 203 may be implemented as one or more microprocessors, microcomputers, microcontrollers, digital signal processors, central processing units, state machines, logic circuitries, and/or any device that manipulates signals based on operational instructions. Among other capabilities, the processor 203 is configured to fetch and execute computer-readable instructions and data stored in the memory 201. In an embodiment of the disclosure, the processor 203 may be configured to perform the method as explained in reference to FIG. 3.

In an embodiment of the disclosure, the image capturing device 205 may be used to capture real-world raw images of real-world scene 204. In an embodiment of the disclosure, the image capturing device 205 is attached to the system 200B.

The modules 207 amongst other things, include routines, programs, objects, components, data structures, etc., which perform particular tasks or implement data types. The modules 207 may also be implemented as, signal processor(s), state machine(s), logic circuitries, and/or any other device or component that manipulates signals based on operational instructions.

Further, the modules 207 can be implemented in hardware, instructions executed by a processing unit, or by a combination thereof. The processing unit can comprise a computer, a processor, such as the processor 203, a state machine, a logic array, or any other suitable wearable device capable of processing instructions. The processing unit can be a general-purpose processor which executes instructions to cause the general-purpose processor to perform the required tasks or, the processing unit can be dedicated to performing the required functions. In another embodiment of the disclosure, the modules 207 may be machine-readable instructions (software) that, when executed by a processor/processing unit, perform any of the described functionalities.

In some embodiments of the disclosure, the modules 207 may include a set of instructions that may be executed by the processor 203 to cause the system 200B to perform any one or more of the methods disclosed herein. The modules 207 may be configured to perform the steps of the disclosure using the data stored in the memory 201 to estimate the depth of the one or more image frames associated with real-world scene 204, as discussed throughout this disclosure. In an embodiment of the disclosure, each of the modules 207 may be hardware units that may be outside the memory 201.

In an embodiment of the disclosure, the modules 207 may include an extraction module 209, a subset sampling module (SSM) 211, and a depth estimation module 213.

The various modules 209-213 may be in communication with each other. In another embodiment of the disclosure, the processor 203 may be configured to perform the functions of modules 209-213. Further, it should be noted that although the depth estimation module 213 is depicted as being a part of the system 200B, the depth estimation module 213 could also be external to the system 200B and connected to it via the network.

It should be noted that in an embodiment of the disclosure, the system 200B may be external to the HMD 206 and connected to it via a network. In another embodiment of the disclosure, the system 200B may be a part of the HMD 206.

At least one of the plurality of modules may be implemented through an AI model. A function associated with AI may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU).

The one or a plurality of processors control the processing of the input data in accordance with a predefined operating rule or artificial intelligence (AI) model stored in the non-volatile memory and the volatile memory. The predefined operating rule or artificial intelligence (AI) model is provided through training or learning. Here, being provided through learning means that, by applying a learning technique to a plurality of learning data, a predefined operating rule or AI model of a desired characteristic is made. The learning may be performed in a device itself in which AI according to an embodiment is performed, and/or may be implemented through a separate server/system. The AI model may consist of a plurality of neural network layers. Each layer has a plurality of weight values and performs a layer operation through the calculation of a previous layer and an operation of a plurality of weights. Examples of neural networks include but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks. The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to the disclosure, a method for estimating the depth of one or more image frames for use in a head-mounted device (HMD) may use an artificial intelligence model to recommend/execute the plurality of instructions by using the one or more image frames. The processor may perform a pre-processing operation on the data to convert into a form appropriate for use as an input for the artificial intelligence model. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values. Reasoning prediction is a technique of logical reasoning and predicting by determining information and includes, e.g., knowledge-based reasoning, optimization prediction, preference-based planning, or recommendation.

Referring to FIGS. 3 and 4, are explained in conjunction with each other. As shown in FIG. 4, at operation 401, the method 400 may include capturing the one or more image frames. In an embodiment of the disclosure, the one or more image frames, as shown at block 301 of FIG. 3, may be associated with the real-world scene 204 and may be captured by the image capturing device 205 of the system 200B. In an embodiment of the disclosure, the one or more image frames may be a virtual image frame corresponding to a virtual image.

Then, at operation 403, the method 400 may include extracting one or more features from each of the one or more image frames. In an embodiment of the disclosure, the extraction module 209 may extract the one or more features from each of the one or more image frames. In an embodiment of the disclosure, the extraction module 209 may be an artificial intelligence (AI) module, such as a deep learning module that extracts the one or more features, as shown at block 303, 305 of FIG. 3, that are used in predicting a minimum number of depth sampling points for estimating the depth of each of the one or more image frames, as discussed in respect of step 305. In an embodiment of the disclosure, the one or more features may include but are not limited to a planar region feature, latent feature, dense region feature, relational feature, edge feature, and a combination thereof. The planar region feature(s) are used to identify what parts of the image frame are planes and what parts are not. The latent features are the non-interpretable features that are extracted by the feature extraction module 209. These features are learnt through backpropagation and helps in predicting a good set of depth sampling points. The dense region feature(s) may be used to identify regions of the image frame that have a lot of objects and/or variation in depth (dense) and regions that are relatively flat (sparse). The relational feature(s) are used to identify the spatial relationships between objects in the image frame. For example, object A is (on top/behind/in front/behind/beside) of object B in the image frame. The edge feature(s) are used to identify edges in a red, green, and blue (RGB) image frame. The RGB frame may be a part of the one or more image frames. Edges can be a great indicator of a large depth gradient. The extraction module 209 may also be trained through backpropagation via the subset sampling module 211.

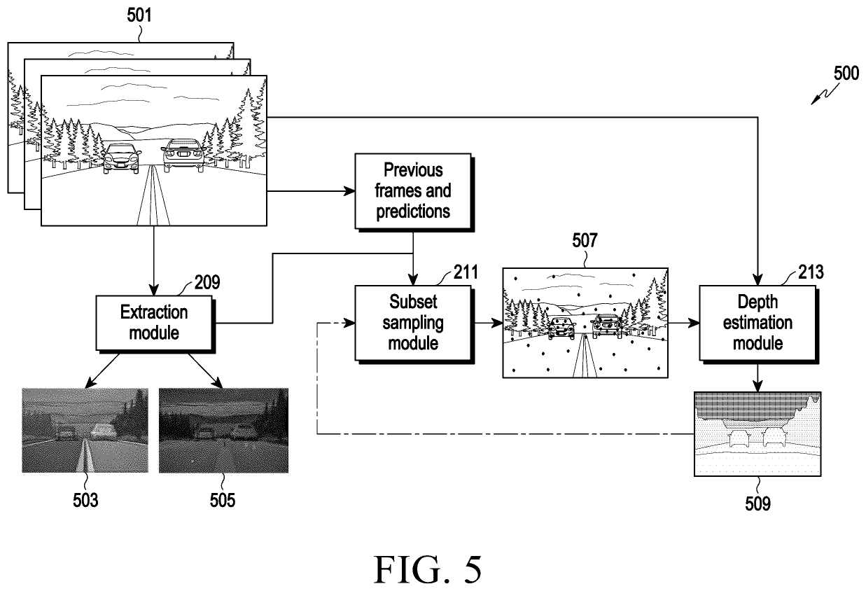

Thereafter, at operation 405, the method 400 may include predicting a minimum number of depth sampling points for estimating the depth of each of the one or more image frames using the one or more extracted features. In an embodiment of the disclosure, the minimum number of depth sampling points may be estimated using an AI model, such as the subset sampling module 211. Further, the AI model, such as the subset sampling module 211 may predict the minimum number of depth sampling points, as shown at block 307 of FIG. 3, in accordance with techniques as described in respect of FIGS. 5 to 7.

Thereafter, at operation 407, the method 400 may estimate the depth 310 of each of the one or more image frames using the corresponding minimum number of depth sampling points. In an embodiment of the disclosure, the depth estimation module 213 may estimate the depth of each of the one or more image frames, as shown at block 309 of FIG. 3, in accordance with techniques known to a person skilled in the art. In an embodiment of the disclosure, the depth of each image frame includes depth information associated with each pixel in the image frame. It should be noted that the depth estimation module 213

FIG. 5 illustrates a workflow diagram 500 for predicting a minimum number of depth sampling points according to an embodiment of the disclosure.

Referring to FIG. 5, the SSM 211 receives one or more previous image frames 501 along with a plurality of previously predicted depth sampling points corresponding to the one or more previous image frames. The one or more previous image frames are adjacent to a current image frame of the one or more image frames 301. The plurality of predicted depth sampling points also corresponds to the points predicted in the one or more previous frames. The SSM 211 also receives previously estimated depth corresponding to the one or more previous image frames 501. The previously estimated depth is the depth map of the one or more previous image frames. Then, the SSM 211 determines correspondences between each of the one or more previous image frames and the current image frame. More particularly, the SSM 211 may determine correspondences between the frames where the correspondences may include correspondences between each of the objects present in the one or more previous image frames and each of the objects present in the current image frame. The correspondences may also include the position of the object, the size of the object, brightness of the object and similar features in the frame. In an example as shown in FIG. 5, the correspondences may include the position of the cars on the road in the one or more previous image frames and the current image frame.

Then, the SSM 211 may determine one or more latent features from the one or more features 503, 505 by fusing the determined correspondences, the plurality of previously predicted depth sampling points, the previously estimated depth, and a confidence score associated with the previously estimated depth for each of the one or more previous image frames, into a latent space representation. The confidence score may define the level of accuracy of the corresponding estimated depth of the corresponding previous image frame. Then, the SSM 211 may predict the minimum number of depth sampling points, as shown at block 507, based on one or more latent features. The process defined in respect to FIG. 5 helps in reduction of depth sampling points for the current image frame as many points in the current image frame have been covered in the previous image frames. Hence, the SSM 211 mainly focusses the prediction on the regions that are being viewed for the first time and the denser areas. This prediction process of the SSM 211 is repeated for all the images where the SSM 211 considers the previous image frames, predicted depth maps and correspondences for predicting the depth sampling points for the current image frame. Then, the depth estimation module 213 may estimate the depth of the current image frame, as shown at block 509, using the minimum number of depth sampling points and the one or more previous image frames. The depth estimation module 213 may estimate the depth in accordance with techniques known in the art.

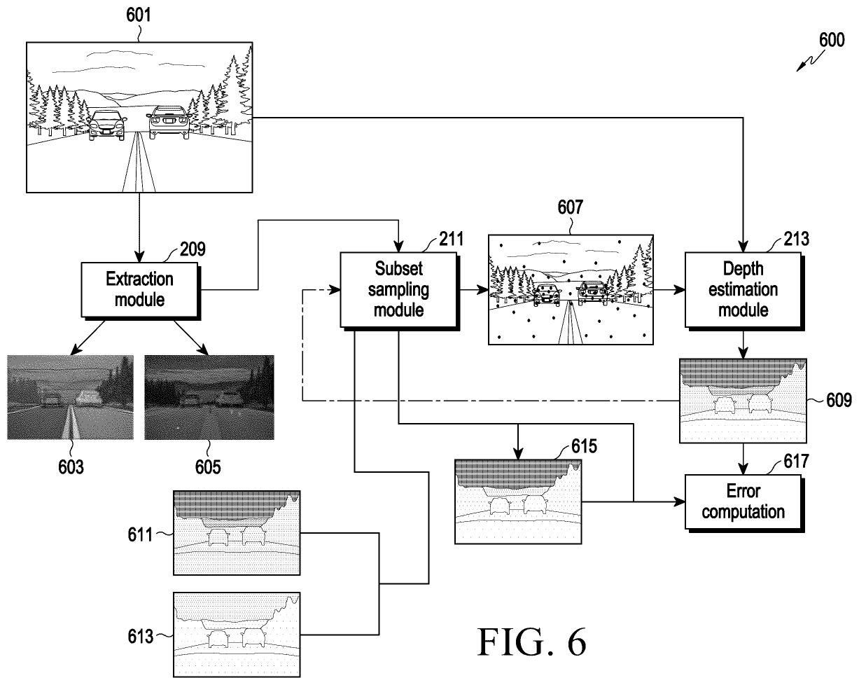

FIG. 6 illustrates a workflow diagram 600 for predicting a minimum number of depth sampling points according to an embodiment of the disclosure.

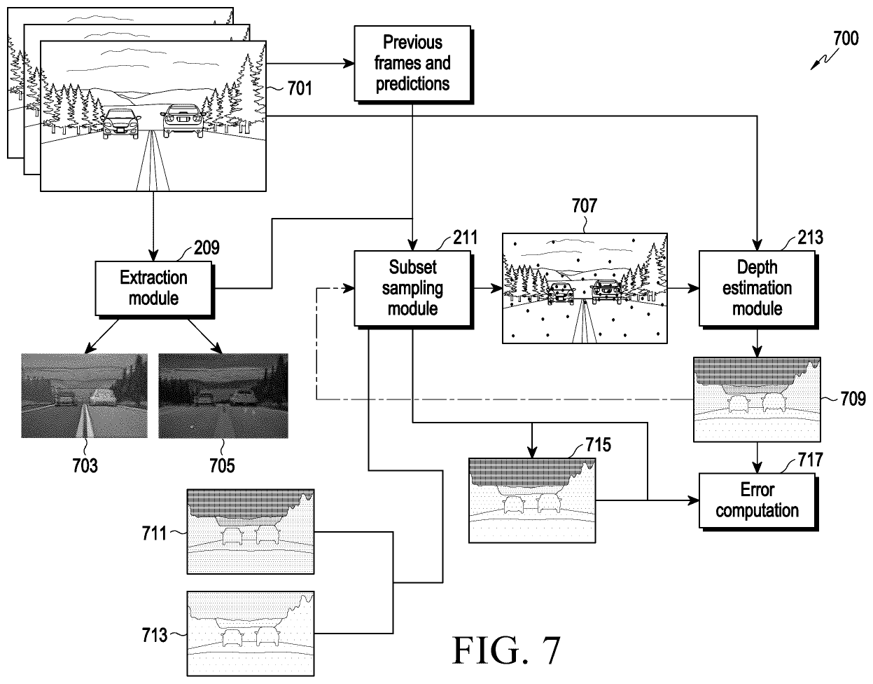

Referring to FIG. 6, in this embodiment of the disclosure, the SSM 211 receives an activity information of a user using the HMD 206. The activity information is associated with a frequently visited area in a current image frame 601 of the one or more image frames 603 or 605. For example, if the user has visited the road of the real-world road scene 204 frequently, then the SSM may receive the activity information associated with the road if the frequently visited area is present in the current image frame. In an embodiment of the disclosure, the SSM 211 may receive the activity information from a module/component, such as a location component associated with the HMD 206. The said component may store the activity information of the user and then may determine that a given area in the current image frame is the frequently visited area and may accordingly, provide this information to the SSM 211. Then, the SSM 211 may receive a first pseudo ground truth depth map 611 (711 in FIG. 7) from one or more depth estimation process, as shown at block 607. In an embodiment of the disclosure, the one or more depth estimation process may correspond to any depth estimation process used by the HMD 206 and known to a person skilled in the art. The first pseudo ground truth depth map 611 may correspond to the current image frame. As the current image frame is a frequently visited area, the one or more depth estimation process may already have a ground truth map associated with the frequently visited area and may accordingly provide a corresponding pseudo ground truth map, i.e., a first pseudo ground truth map to the SSM 211. The SSM 211 may also receive a second pseudo ground truth depth map 613 (713 in FIG. 7) from an indirect time of flight (I-ToF) sensor. In an embodiment of the disclosure, the I-ToF sensor is connected with the HMD 206. As the current image frame is a frequently visited area, the I-ToF sensor may already have a ground truth map associated with the frequently visited area and may accordingly provide a corresponding pseudo ground truth map i.e., a second pseudo ground truth map to the SSM 211. The SSM 211 may then generate a pseudo ground truth depth map 615 by fusing the first pseudo ground truth depth map and the second pseudo ground truth depth map. The SSM 211 may then update a plurality of weights of the SSM 211 using an error, as shown at block 617, between the pseudo ground truth depth map 615 and a predicted depth map of the frequently visited area. The first and second pseudo ground truth map helps in increasing the speed and efficiency of the SSM 211. In an embodiment of the disclosure, the SSM 211 may determine the predicted depth map based on data received from other sensors, such as I-ToF sensor. The plurality of weights is associated with the SSM 211. Thereafter, the SSM 211 may predict the minimum number of depth sampling points using the updated SSM 211 that is updated using the updated plurality of weights. The depth estimation module 213 may then estimate the depth using the minimum number of depth sampling points 609. The depth estimation module 213 may estimate the depth in accordance with techniques known in the art.

FIG. 7 illustrates a workflow diagram 700 for predicting a minimum number of depth sampling point according to an embodiment of the disclosure.

Referring to FIG. 7, in this embodiment of the disclosure, the SSM 211 predicts the minimum number of depth samples, as shown at block 707, combining the techniques of the first embodiment and the second embodiment of the disclosure, i.e., techniques disclosed in reference to FIGS. 5 and 6. Accordingly, the SSM 211 determines one or more latent features based on one or more previous frames 703 or 705 as discussed in reference to FIG. 5. Then, the SSM 211 predicts the minimum number of depth sampling points using the updated SSM 211 and one or more latent features associated with the one or previous image frames. The SSM 211 may then be updated as shown at block 717 and in accordance with techniques described in reference to FIG. 6. Then, the SSM 211 may predict the minimum number of depth sampling points using the updated SSM 211. The depth estimation module 213 may then estimate the depth using the minimum number of depth sampling points. The depth estimation module 213 may estimate the depth in accordance with techniques known in the art.

In another embodiment of the disclosure, the AI model may be trained using a reward model. For example, the reward model evaluates the depth map output of the depth estimation module 213. The reward model may use a reward to train the AI model. The reward is a weighted function of depth errors at different ranges (short, medium and long) as well as the number of points sampled by the subset sampling module 211. In an embodiment of the disclosure, the depth errors are the errors between a ground truth depth map 715 and a predicted depth map. In an embodiment of the disclosure, the AI model may receive the ground truth map and may predict the predicted depth map corresponding to the one or more image frames provided during the training. The AI model may determine these maps using techniques known in the art. In another embodiment of the disclosure, the depth errors are the errors between a pseudo ground truth depth map and the predicted depth map. Accordingly, the AI model may receive the pseudo ground truth map and may predict the predicted depth map corresponding to the one or more image frames provided during the training. The AI model may determine these maps using techniques known in the art. The reward is high when the number of sampled points and the depth errors at all ranges are low. Accordingly, if the reward is high, it may be determined that the AI model is minimizing the depth sampling points. Accordingly, the reward model uses a number of depth sampling points and a weighted function of depth errors between the ground truth depth map and the predicted depth map to train the AI model.

In an embodiment of the disclosure, the AI model may predict the minimum number of depth sampling points 709 using an exploration/exploitation tradeoff.

Accordingly, the disclosure provides techniques for estimating the depth of the one or more image frames for use in the HMD. Further, it should be noted that the techniques as described herein with reference to FIGS. 3 to 7 may be performed by the HMD 206 when the system 200B is a part of the HMD 206.

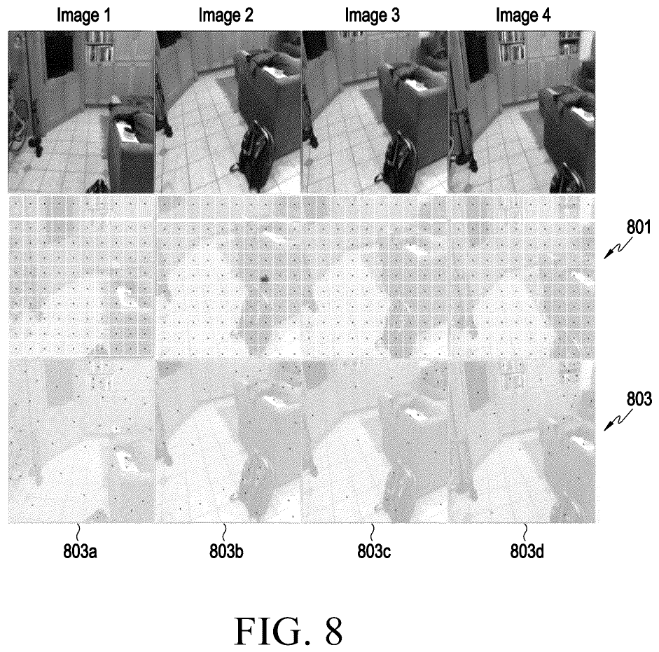

FIG. 8 illustrates a comparison between depth sampling point required to estimate a depth of an image frame using an existing technique and a disclosed techniques according to an embodiment of the disclosure.

Referring to FIG. 8, the depth sampling points (represented by 801) sampled by existing technique, such as uniform sampling is much more than the depth sampling points predicted by the disclosure (represented by 803) for each of the image frames i.e., image frames 1, 2, 3, and 4. For example, a high number of depth sampling points, such as 100 points, are required for each of the image frames 1, 2, 3, 4, in accordance with existing uniform sampling technique. In contrast, according to the methods described in this disclosure, image frames require significantly fewer sampling points compared to the uniform sampling technique. For instance, image frame 1 needs 48 sampling points (represented by 803a), while image frame 2 requires even fewer, around 32 (represented by 803b), as many points have already been covered in frame 1. Similarly, image frame 3 requires just 20 sampling points (represented by 803c), since the scene remains largely unchanged from frames 1 and 2. However, image frame 4 introduces new elements, such as a bookshelf on the right, and includes denser areas that have not been previously viewed. As a result, a little bit more samples are needed for this image frame as new items in view compared to previous frames. Hence, image frame 4 requires slightly more sampling points, about 28 sampling points (represented by 803d), than frame 3.

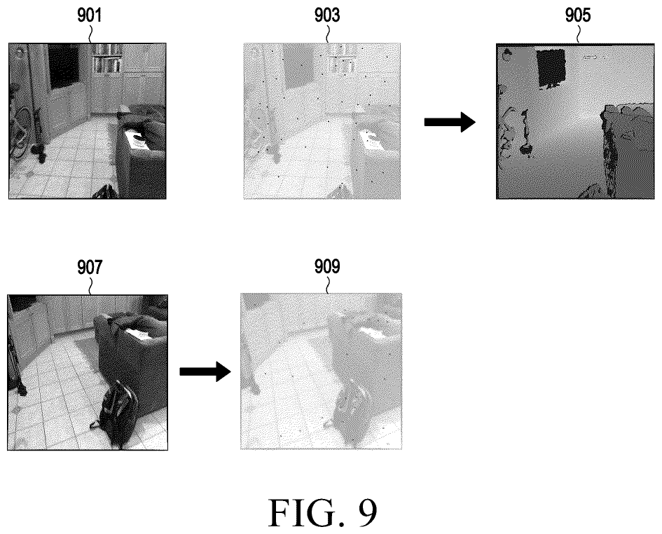

FIG. 9 illustrates a use case scenario for estimating a depth of a one or more image frames for use in an HMD according to an embodiment of the disclosure.

Referring to FIG. 9, let us consider a scenario where the HMD 206 is operating in an indoor environment. Accordingly, the HMD 206 captures a sequence of image frames through its camera sensors. Let us consider that the first image, i.e., current image 901 in the sequence is captured and accordingly, the extraction module 209 extracts the following one or more features associated with the current image frame:
Planar features: Floor, cupboards, television (TV) and sofa sides
Dense regions: Regions of the image with several objects, for example, region with bicycle, bookshelf, top of sofa etc.
Relational Features: Features that capture relations between objects in the image, for example: TV on side cupboard, paper on sofa, books within cupboard, bicycle on floor.
Edge features: Edges present in the image. These features help identify areas where the depth gradient (difference of depth in adjacent pixels) is large.
Latent Features: These are the non-interpretable features that are extracted by the feature extraction module. These features are learnt through backpropagation and helps the SSM sample a good set of points.

The SSM 211 then predicts minimum number of depth sampling points, as shown at block 903, for estimating the depth of the current image frame using the one or more extracted features. The current image frame 901 and the depth sampling points 903 sampled by the SSM 211 are then passed as inputs to the depth estimation module 213, to infer the depth map 905 of the current image frame. The HMD 206 then captures the next image frame 907, which is now the current image frame. However, SSM 211 already has subset of depth samples of the previous image frame 901, which is very slightly different from the current image frame 907. The information of the subset of previously sampled points, previously predicted depth in conjunction with the correspondences between the previous and current image are used by the SSM 211 to predict the depth sampling points of the current image frame 907. The SSM 211 now needs lesser samples in the current image frame 907, as lot many points in the image frame 907 have been covered in the previous image frame 901. Hence, the SSM 211 mainly focusses the prediction on the regions that are being viewed for the first time and the denser areas. The final estimate depth maps can then be used for several use cases that require an accurate depth map of the scene. These use-cases may include but are not limited to 3-dimensioomal (3D) scene reconstruction, 3D object recognition, and determining virtual object placement.

Accordingly, the disclosure provides various advantages. For example, the disclosure provides efficient depth sampling techniques to estimate the depth of an image. Further, the disclosed techniques result in a reduced number of depth sampling points required to estimate the depth of the image.

Unless otherwise defined, all technical and scientific terms used herein have the same meaning as commonly understood by one of ordinary skilled in the art to which this disclosure belongs. The system, methods, and examples provided herein are illustrative only and not intended to be limiting.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for controlling a head-mounted device (HMD), the method comprising:
obtaining, by the HMD, the one or more image frames;
identifying, by the HMD, one or more features from each of the one or more image frames;
determining, by the HMD, a minimum number of depth sampling point for estimating a depth of the one or more image frames using the one or more identified features, and
estimating, by the HMD, the depth of the one or more image frames using the minimum number of depth sampling point.

2. The method of claim 1, wherein the determining of the minimum number of depth sampling point comprises:
determining the minimum number of depth sampling point by an artificial intelligence AI model.

3. The method of claim 1, wherein the determining of the minimum number of depth sampling point comprises:
receiving one or more previous image frames adjacent to a current image frame of the one or more image frames, a plurality of previously determined depth sampling points corresponding to the one or more previous image frames, and previously estimated depth corresponding to the one or more previous image frames, and
determining the minimum number of depth sampling point based on one or more latent features associated with the one or more previous image frames for estimating the depth of the current image frame.

4. The method of claim 3, wherein prior to the determining of the minimum number of depth sampling point, the method comprising:
determining correspondences between each of the one or more previous image frames and the current image frame; and
determining the one or more latent features from the one or more features by fusing the determined correspondences, the plurality of previously determined depth sampling points, the previously estimated depth, and a confidence score associated with the previously estimated depth for each of the one or more previous image frames, into a latent space representation.

5. The method of claim 3, wherein the depth of the current image frame is estimated using the minimum number of depth sampling point, and the one or more previous image frames.

6. The method of claim 1, wherein the determining of the minimum number of depth sampling point comprises:
receiving an activity information of a user using the HMD, wherein the activity information is associated with a frequently visited area in a current image frame of the one or more image frames;
updating a plurality of weights of an artificial intelligence (AI) model using an error between a pseudo ground truth depth map and a determined depth map of the frequently visited area; and
determining the minimum number of depth sampling point using the updated AI model.

7. The method of claim 6, wherein prior to the determining of the minimum number of depth sampling point using the updated AI model, the method comprising:
generating the pseudo ground truth depth map by fusing a first pseudo ground truth depth map received from one or more depth estimation process and a second pseudo ground truth depth map received from an indirect time of flight (I-ToF) sensor.

8. A head-mounted device (HMD), the HMD comprising:
an image capturing device configured to obtain the one or more image frames;
memory storing one or more computer programs; and
a processor communicatively coupled to the image capturing device and the memory,
wherein the one or more computer programs include computer-executable instructions that, when executed by the processor, cause the HMD to:
identify one or more features from each of the one or more image frames,
determine a minimum number of depth sampling point for estimating the depth of each of the one or more image frames using the one or more identified features, and
estimate the depth of each of the one or more image frames using the corresponding minimum number of depth sampling point.

9. The HMD of claim 8, wherein the one or more computer programs further include computer-executable instructions that, when executed by the processor, cause the HMD to determine the minimum number of depth sampling point using an AI model.

10. The HMD of claim 8, wherein, for predicting the minimum number of depth sampling points, the one or more computer programs further include computer-executable instructions that, when executed by the processor, cause the HMD to:
receive one or more previous image frames adjacent to a current image frame of the one or more image frames, a plurality of previously determined depth sampling points corresponding to the one or more previous image frames, and previously estimated depth corresponding to the one or more previous image frames, and
determine the minimum number of depth sampling point based on one or more latent features associated with the one or more previous image frames for estimating the depth of the current image frame.

11. The HMD of claim 10, wherein, prior to determining the minimum number of depth sampling point, the one or more computer programs further include computer-executable instructions that, when executed by the processor, cause the HMD to:
determine correspondences between each of the one or more previous image frames and the current image frame, and
determine the one or more latent features from the one or more features by fusing the determined correspondences, the plurality of previously determined depth sampling points, the previously estimated depth, and a confidence score associated with the previously estimated depth for each of the one or more previous image frames, into a latent space representation.

12. The HMD of claim 10, wherein the depth of the current image frame is estimated using the minimum number of depth sampling point, and the one or more previous image frames.

13. The HMD of claim 8, wherein, for determining the minimum number of depth sampling point, the one or more computer programs further include computer-executable instructions that, when executed by the processor cause the HMD to:
receive an activity information of a user using the HMD, wherein the activity information is associated with a frequently visited area in a current image frame of the one or more image frames,
update a plurality of weights of an AI model using an error between a pseudo ground truth depth map and a determined depth map of the frequently visited area, and
determine the minimum number of depth sampling point using the updated AI model.

14. The HMD of claim 13, wherein, prior to determining the minimum number of depth sampling point using the updated AI model, the one or more computer programs further include computer-executable instructions that, when executed by the processor, cause the HMD to:
generate the pseudo ground truth depth map by fusing a first pseudo ground truth depth map received from one or more depth estimation process and a second pseudo ground truth depth map received from an indirect time of flight (I-ToF) sensor.

15. The HMD of claim 13, wherein, for determining the minimum number of depth sampling point, the one or more computer programs further include computer-executable instructions that, when executed by the processor, cause the HMD to:
receive one or more previous image frames adjacent to a current image frame of the one or more image frames, a plurality of previously determined depth sampling points corresponding to the one or more previous image frames, and previously estimated depth corresponding to the one or more previous image frames, and
determine the minimum number of depth sampling point using the updated AI model and one or more latent features associated with the one or previous image frames.

16. The HMD of claim 15, wherein, prior to determining the minimum number of depth sampling point using the AI model and the one or more latent features, the one or more computer programs further include computer-executable instructions that, when executed by the processor, cause the HMD to:
determine correspondences between the one or more previous image frames and the current image frame, and
determine the one or more latent features by fusing the determined correspondences, the plurality of previously determined depth sampling points, the previously estimated depth, and a confidence score associated with the previously estimated depth for each of the one or more previous image frames, into a latent space representation.

17. The HMD of claim 9,
wherein the AI model is trained using a reward model, and
wherein the reward model uses a number of depth sampling points and a weighted function of depth errors between a determined depth map and one of a ground truth depth map or a pseudo ground truth depth map.

18. The HMD of claim 8, wherein the one or more features include a planar region feature, latent feature, dense region feature, relational feature, edge feature, and a combination thereof.

19. The HMD of claim 8, wherein one or more image frames is a virtual image frame.

20. One or more non-transitory computer-readable storage media storing one or more computer programs including computer-executable instructions that, when executed by one or more processors of a HMD individually or collectively, cause the HMD to perform operations, the operations comprising:
obtaining, by the HMD, the one or more image frames;
identifying, by the HMD, one or more features from each of the one or more image frames;
determining, by the HMD, a minimum number of depth sampling point for estimating a depth of the one or more image frames using the one or more identified features, and
estimating, by the HMD, the depth of the one or more image frames using the minimum number of depth sampling point.
